(19) United States
(12) Patent Application Publication
(10) Pub. No.: US 2025/0314871 A1
(43) Pub. Date: Oct. 9, 2025

(54) SINGLE VIEWPOINT TOMOGRAPHY SYSTEM USING POINT SPREAD FUNCTIONS OF TILTED PSEUDO-NONDIFFRACTING BEAMS

(71) Applicant: B.G. NEGEV TECHNOLOGIES AND APPLICATIONS LTD., AT BEN-GURION UNIVERSITY, Beer Sheva (IL)

(72) Inventors: Joseph ROSEN, Omer (IL); Nathaniel HAI, Beer Sheva (IL)

(21) Appl. No.: 18/865,926

(22) PCT Filed: May 17, 2023
(86) PCT No.: PCT/IL2023/050505

§ 371 Date: Nov. 14, 2024

Related U.S. Application Data
(60) Provisional application No. 63/343,107, filed on May 18, 2022.

(51) Int. Cl. G02B 21/36; G02B 21/08

(52) U.S. Cl. CPC G02B 21/367; G02B 21/088

(57) ABSTRACT

The invention relates to a single viewpoint imaging system for optically sectioning an object from a single viewpoint, comprising: (a) a TPNDBs (tilted pseudo-nondiffracting beams)-type coded phase mask (CPM) configured to receive a light beam passed through the object or reflected therefrom, and to produce TPNDBs directed towards a sensing array; (b) said sensing array configured to record an image formed by said TPNDBs impinged thereon; (c) a processor configured to: (c1) separately cross-correlating said recorded image with at least one point-spread function (PSF) previously acquired or calculated at the same system with the same CPM, each said PSF reflects a point object positioned at one specific longitudinal distance, respectively, from said array; (c2) storing the results of said separate cross-correlations, each such cross-correlation result relates to an image of another section, respectively, of the object; and (c3) uniting all said cross-correlation results to reconstruct a final image of the object.

### FIELD OF THE INVENTION

The field of the invention relates in general to holography-type imaging systems.

### BACKGROUND OF THE INVENTION

Optical sectioning and tomography have been considered sought-after characteristics in optical microscopy, providing in-depth clear images of thick objects slice-by-slice. However, the long scanning process of such systems has hindered their use in important scenarios such as following the brain neural activity or cell growth rate, which require less than a millisecond temporal resolution.

During the last two decades, optical microscopy has been extensively established as a noninvasive imaging tool capable of resolving structures on a scale of a few hundred nanometers. Optical microscopy can be broadly classified as widefield microscopy, in which the entire sample is illuminated and imaged by refractive lenses, or scanning microscopy, in which all the scanned volume units of a sample are reconstructed one by one. The difference between the two approaches eventually comes down to the essential three-dimensional (3D) optical sectioning capability, which is conventionally unavailable in widefield microscopes due to out-of-focus (OoF) structures that arrive at the imaging device obscuring parts in the in-focus image. Despite their attractive characteristics, such as simple implementation and rapid imaging, widefield microscopes pose difficulties in applications for visualizing complex and thick samples. Many research groups have proposed diverse optical instruments to close this gap and to enable optical sectioning capabilities in a scanning-less manner with a single or a few samplings.

Interferenceless coded aperture correlation holography (COACH) has been previously proposed, for example, in Vijayakumar, and J. Rosen, “Interferenceless coded aperture correlation holography—a new technique for recording incoherent digital holograms without two-wave interference,” Opt. Express 25(12) 13883-13896 (2017). In COACH, the light diffracted by a point object is modulated by a Coded Phase Mask (CPM) and is interfered with an unmodulated version of the light diffracted from the same point object to form an impulse response hologram. This impulse response hologram serves as a Point Spread Function (PSF), which is used later as the reconstructing kernel function for reconstructing object holograms. Following the PSF generation, a complicated object is placed at the same axial location as the point object, and another hologram, the object hologram, is recorded with the same CPM. Finally, the complicated object's image is reconstructed by cross-correlating between the PSF and the object hologram. For the reconstruction of objects at different axial locations, or imaging depths of the same object, a training phase is performed in which the point object is shifted to various axial locations, and a library of PSFs is created for each axial location. Then, the images of the object at different depths are reconstructed by cross-correlating a modulated object image (the object hologram) obtained by utilizing the same CPM with the appropriate PSF from the library. Several useful properties of COACH, such as high axial resolution, high spectral resolution, and super-resolution capabilities, have been demonstrated. However, the prior art COACH, when applied to tomography, provides relatively poor results due to at least two factors: (a) In COACH, the PSFs (and the following object holograms) are acquired along a specific (single) axis; therefore, the COACH's best results are limited to this axis and significantly degraded out of this axis; and (b) Obscured portions within “slices” of the object cannot be imaged. Therefore, an improved solution is desired, particularly for a widefield (non-scanning) microscope.

The use of “Tilted Pseudo-Nondiffracting Beams (TPNDB)” as a point spread function (PSF) in a linear system has been suggested in J. Rosen, B. Salik, and A. Yariv, “Pseudo-nondiffracting beams generated by radial harmonic functions,” J. Opt. Soc. Am. A 12, 2446-2457 (1995). However, this technique has never been proposed in conjunction with widefield or scanning microscopes, or with image sectioning and tomography. More specifically, the TPNDB technique has not been suggested to provide a widefield microscope (namely a “stationary microscope without scanning) with the ability of optical sectioning without obstructions, which is essential for 3D imaging.

It is an object of the invention to provide a single viewpoint system capable of optical sectioning an object without obstructions.

Another object of the invention is to provide the conventionally used widefield microscope with the ability of optical sectioning without obstructions, which is essential for 3D imaging.

It is still another object of the invention to eliminate the necessity for scanning in the scanning-type microscope, thereby significantly reducing the time required for an overall object inspection.

Other objects and advantages of the invention become apparent as the description proceeds.

### SUMMARY OF THE INVENTION

The invention relates to a single viewpoint imaging system for optically sectioning an object from a single viewpoint, comprising: (a) a TPNDBs (tilted pseudo-nondiffracting beams)-type coded phase mask (CPM) configured to receive a light beam passed through the object or reflected therefrom, and to produce TPNDBs directed towards a sensing array; (b) said sensing array configured to record an image formed by said TPNDBs impinged thereon; (c) a processor configured to: (c1) separately cross-correlating said recorded image with at least one point-spread function (PSF) previously acquired or calculated at the same system with the same CPM, each said PSF reflects a point object positioned at one specific longitudinal distance, respectively, from said array; (c2) storing the results of said separate cross-correlations, each such cross-correlation result relates to an image of another section, respectively, of the object; and (c3) uniting all said cross-correlation results to reconstruct a final image of the object.

In an embodiment of the invention, the CPM is produced by a generator unit combining a randomly distributed Dot generator with a Radial Quartic Phase Function (RQPF).

In an embodiment of the invention, the processor further applies a nonlinear reconstruction (NLR) procedure on said final image of the object, thereby to increase signal to noise ratio, and to produce an enhanced final image of the object.

In an embodiment of the invention, the spatial light modulator (SLM), together with the generator unit is used for the production of said CPM.

In an embodiment of the invention, the system is applied within a microscope.

In an embodiment of the invention, the system is applied as an add-on of a widefield microscope.

In an embodiment of the invention, each of the TPNDBs impinges at a different array location, and at a different tilting angle on said sensing array.

The invention also relates to a single viewpoint imaging method for optically sectioning an object from a single viewpoint, comprising: (a) providing a TPNDBs (tilted pseudo-nondiffracting beams)-type coded phase mask (CPM); (b) generating a light beam which illuminates or passes through the object and directing the light beam that passed through or reflected from the object towards said CPM, thereby to produce TPNDBs at a sensing array; (c) recording an image formed at said sensing array by said TPNDBs impinged thereon; (d) separately cross-correlating said recorded image with at least one point-spread function (PSF) previously acquired or calculated at a same optical arrangement with the same CPM, each said PSF reflects a point object positioned at one specific longitudinal distance, respectively, from said array; (e) storing the results of said separate cross-correlations, each such cross-correlation result relates to an image of another section, respectively, of the object; and (f) uniting all said cross-correlation results to reconstruct a final image of the object.

In an embodiment of the invention, the CPM is produced by a generator unit combining a randomly distributed Dot generator with a Radial Quartic Phase Function (RQPF).

In an embodiment of the invention, the method further applies a nonlinear reconstruction (NLR) procedure on said final image of the object, thereby to increase signal to noise ratio, and to produce an enhanced final image of the object.

In an embodiment of the invention, a spatial light modulator (SLM), combined with the generator unit are used to produce said CPM.

In an embodiment of the invention, the method is applied within a microscope.

In an embodiment of the invention, the method is applied as an add-on process within a widefield microscope.

In an embodiment of the invention, the method is applied each of the TPNDBs impinges at a different array location, and at a different tilting angle on said sensing array.

### BRIEF DESCRIPTION OF THE DRAWINGS

In the drawings:

FIG. 1 illustrates in a schematic block diagram form the general structure of a prior art COACH System;

FIG. 2 illustrates in a general flow diagram a prior art COACH process performed by the COACH system of FIG. 1;

FIG. 3 illustrates in a schematic block diagram form the general structure of the STIR system of the invention;

FIG. 4 illustrates, in a general flow diagram form, the process performed by the STIR system of FIG. 3;

FIG. 5 illustrates how a light beam, after passing through a CPM, is split into a plurality of spatially distributed TPNDBs that in turn, each impinges a sensing array at a respective array location;

FIG. 6a shows an embodiment of the STIR system of the invention operating in a light reflection mode;

FIG. 6b shows an embodiment of the STIR system of the invention operating in a light transmission mode;

FIG. 7 generally illustrates a process performed while testing the STIR system of the invention;

FIG. 8 illustrates the calibration and validation of a STIR system, as performed during experiments;

FIG. 9 shows a comparison between the COACH and STIR in rejecting out-of-focus images, as performed in an experiment;

FIG. 10 compares holographic tomography of a volumetric scene by several techniques;

FIG. 11 shows holographic tomography of fluorescent microspheres using STIR compared with two other approaches.

### DETAILED DESCRIPTION OF PREFERRED EMBODIMENTS

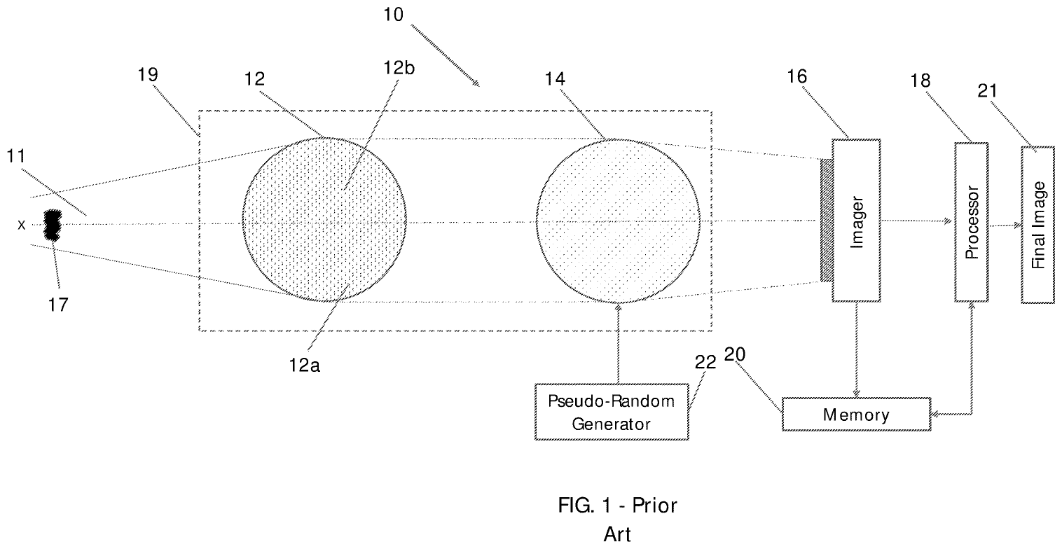

FIG. 1 illustrates in a schematic block diagram form the general structure of a prior art COACH System 10 viewing scenery (which in the case of a microscope is an object 17). The system views scenery 11 via lens (aperture) 12. The image seen by lens 12 is conveyed to a Coded Phase Mask (CPM) 14. In some cases, the lens 12 and the CPM 14 may be combined into a single integral lens-modulator unit. In case lens 12 and CPM 14 are not combined, the gap between them is typically negligibly small. Additionally, the order of their appearance is irrelevant, i.e., if CPM 14 is closer to the scenery than lens 12, the system operates identically to the case when lens 12 is closer to the scenery. Practically, the CPM 14 is a modulator that modulates the phases of each of the pixels of the image acquired by lens 12. The CPM may include, for example, an array of liquid-crystal pixels. A generator 22 provides a code to the CPM which modulates the pixels of the array such that the resulting output phases of the individual pixels of the CPM 14 are varied. Therefore, imager 16 (a sensor, such as a digital camera) views a converted image of the scenery, as seen by lens 12 and converted by CPM 14. System 10 also includes a memory 20 for storing images and image functions (the PSFs) and a processor 18, which processes the stored images to create a final image 21.

For better clarity, lens 12, the CPM 14, and other elements are rotated by 90° relative to their actual orientation with respect to the scenery.

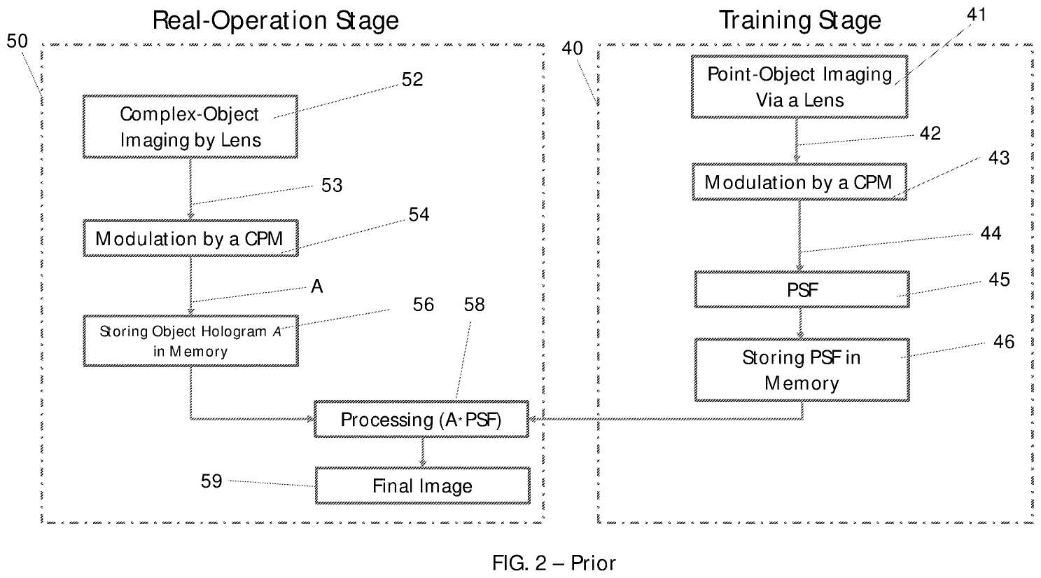

FIG. 2 illustrates in a general flow diagram a prior art COACH process 50, as performed by the COACH system of FIG. 1. Initially, the system goes through a training stage 40. In step 41, a point-object at a selected axis, typically the central axis of the system, is imaged through lens 12 (of FIG. 1) to form a point image 42. Point image 42 is conveyed to the modulated coded phased mask (CPM) 14 (FIG. 1), which in turn modulates (step 43) the phases of various pixels of the point image 42 to form a point-object image (POI) 44. POI 44 is defined as a Point-Spread-Function (PSF) 45. The PSF 45 is then stored 46 in memory 20 of the system of FIG. 1. To provide accurate imaging, a plurality of point images are acquired along the main axis x and stored in memory 20.

In a real operation stage 50, a complex object is imaged 52 via the same lens 12 of FIG. 1 to form an object image 53, which is conveyed to the coded phased mask (CPM) 14 (of FIG. 1). CPM 14, which is the same mask that was used during the training stage, modulates 54 the phases of the pixels of the object image 53 to form a Complex Object Image (COI) A. For the modulation, the CPM 14 uses the same code provided by the generator 22 and used by the CPM 14 during the training stage 40. The COI A is conveyed to memory 20, and stored 56. The final image is created in step 58 by a cross-correlation between the PSF (previously stored in step 46 of the training stage) and the COI A (stored in step 56 of the real-operation stage 50).

In one embodiment, the system of the invention upgrades the widefield microscope to have an optical sectioning capacity. As described below, the present invention's system utilizes tilted pseudo-nondiffracting beams (TPNDBs) as a linear system's point spread function (PSF). As the point response of the system of the invention utilizes a group of randomly tilted light rods (elaborated hereinafter), it is referred to as a Sectioning by Tilted Intensity Rods system (STIR).

The STIR system of the invention utilizes a sparse coded aperture correlation hologram of tilted pseudo-nondiffracting beams to map the entire volume of interest from a single viewpoint without scanning. Volumetric reconstructions of phantoms of transmissive thick objects and a fluorescent specimen from a single-viewpoint bipolar hologram are demonstrated.

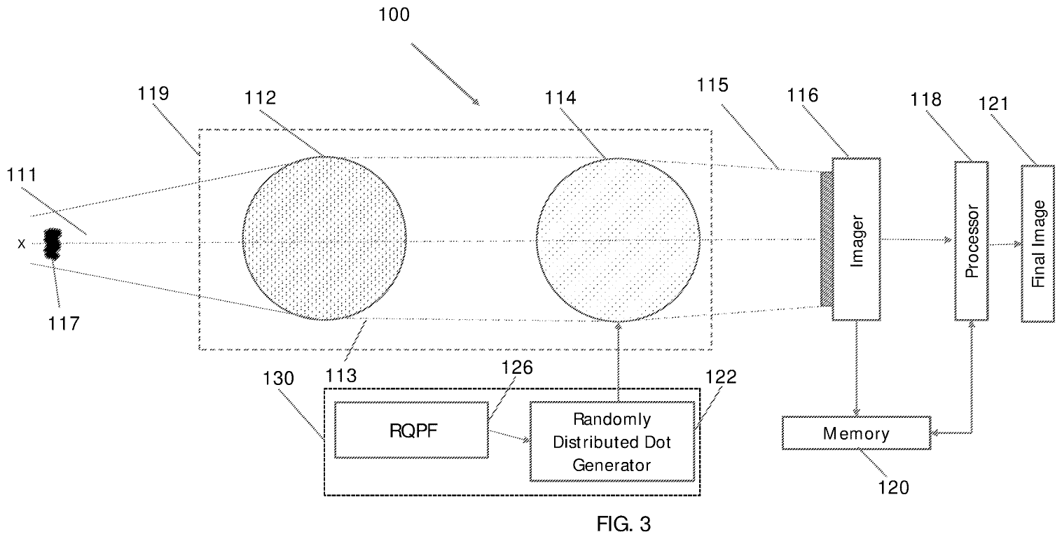

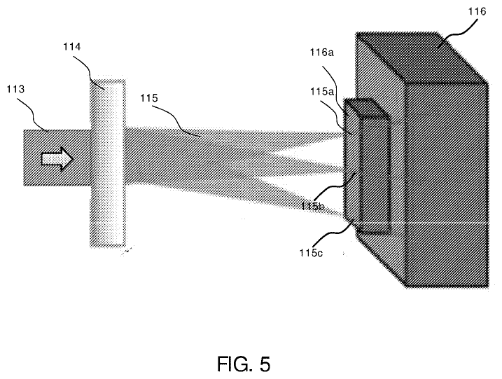

FIG. 3 illustrates in a schematic block diagram form the general structure of the STIR system of the invention. The system is similar to the COACH system of FIG. 1, so similar numerals indicate similar functionalities (and therefore, for brevity, they are not repeated). The STIR system of FIG. 3 mainly differs from the COACH system of FIG. 1 in the type of CPM 114. While the CPM 14 of the COACH is generated for many applications, none of them is for sectioning or tomography, the CPM 114 of the invention is created based on a combination 130 of a Randomly Distributed Dot Generator 122 and a Radial Quartic Phase Function (RQPF) 126. After acquiring image 117, and passing through lens 112, beam 113 passes through the CPM 114, resulting in a plurality of tilted pseudo-nondiffracting beams (TPNDBs) 115, impinging on imager 116 (having a sensing array 116a shown in FIG. 5). FIG. 5 illustrates how beam 115, after passing through CPM 114, is split into a plurality of spatially and angularly distributed TPNDBs 115a, 115b, . . . 115n that in turn, each impinges sensing array 116a at a respective array location. Each TPNDB “rod” possesses, to some degree, information reflecting the entire imaged object 117.

It should be noted that the use of RQPF is only one option for creating the tilted pseudo non diffracting beams (TPNDBs). Other algorithms configured for that purpose may be used.

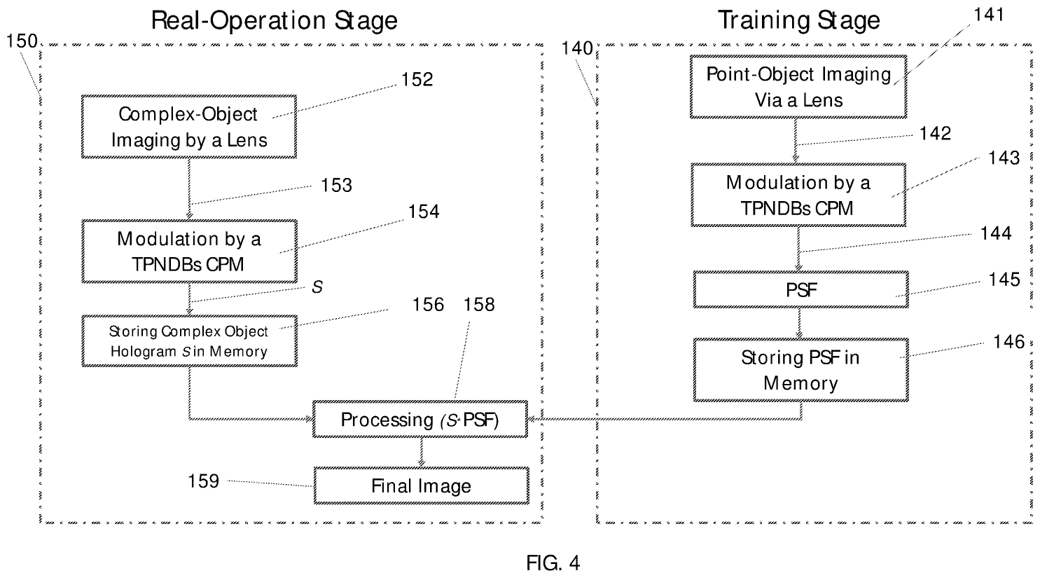

FIG. 4 illustrates, in a general flow diagram form, the process 150 performed by the STIR system (microscope) of FIG. 3. Initially, the system goes through a training stage 140. The training stage might be carried out either physically by performance of one or more tests on the real system, or digitally by processor 118 executing a digital algorithm that mimics the physical system within the computer. In step 141, a point-object at a selected axis, typically the central axis of the system, is imaged through lens 112 (of FIG. 3) to form a point image 142. Point image 142 is conveyed to the TPNDB-CPM 114 (FIG. 3), which in turn modulates (step 143) the phases of various pixels of the point image 142 to form a TPNDB point-object image 144, which is defined as a respective Point-Spread-Function (PSF) 145 referring to TPNDB CPM 114. The PSF 145 is then stored 146 in memory 120 of the system of FIG. 3.

The number of rods within the TPNDBs (as issued after passing the TPNDB-CPM) is predefined—for example, it may include N=8 distinct tilted rods. There are 3 possible modes of operation with the N rods TPNDB. In the first mode, (a) the TPNDB-CPM issues the N rods in N separate sessions (a single rod in each session); in that case, N distinct TPNDB-PSFs are acquired during the training stage 140. In a second mode (b), the TPNDB-CPM issues the entire N rods simultaneously; in that case, a single TPNDB-PSF is acquired during the training stage 140. In a third mode (c), the entire set of N rods is divided into n subsets, for example, 2 distinct subsets, each including a part of the entire set of rods. In that case, the TPNDB-CPM issues each time N/n rods in n separate sessions. In that case, n distinct TPNDB-PSFs are acquired during the training stage 140. As elaborated later, the inventors used n=2 in their experiments, with N=3 and N=4 (6 and 8 rods).

In the real operation stage 150, a complex object is imaged 152 via the same lens used during the training stage to form an object image 153, which is conveyed to the TPNDB-CPM 114 (of FIG. 3). TPNDB-CPM 114, which is the same mask that was used during the training stage. If a plurality of masks were used during the training stage, the real operation (steps 152-156) should be repeated each time with a different mask. The TPNDBs-CPM 114 (FIG. 3) modulates 154 the phases of the pixels of the object image 153 to form a Complex Object Image (COI) S. For the modulation, the TPNDBs-CPM 114 uses the same code provided by the combined RQPF-Randomly Distributed Dot generator 130 and used by the TPNDBs-CPM 114 during the training stage 140. The COI S is conveyed to memory 120, and stored 156. The final image is created in step 158 by a cross-correlation between the one or more TPNDB-PSFs (previously stored in step 146 of the training stage) and the one or more COIs S (stored in step 156 of the real-operation stage 150). In the case of operating in mode (a) (described above), N cross-correlations are performed, and then the N resulting images are united. Alternatively, the images are first united to form a single image, and similarly, the N TPNDB-PSFs are united to form a single TPNDB-PSFs, and only then a single cross-correlation is performed to result in the final image. In the case of operating in mode (b), a single cross-correlation is performed to result in the final image. In the case of operating in mode (c), n cross-correlations are performed, and then the results are united to form the final image. There are various manners for the “uniting” mentioned above, such as averaging, adding, subtracting, etc.

As shown by the examples below, the STIR system of the invention has been found to provide a better resolution and depth performance relative to similar comparable and existing systems. In addition, thanks to the tilting feature used by the TPNDBs of the invention, the system is superior in reflecting obstructed portions within the object. Moreover, the structure of the system of the invention applies to microscopes and other optical viewing systems. All these advantages can be obtained in either light-reflection or light-transmission modes of operation, as further elaborated below.

In one embodiment of the invention, the following RQPF 126 is used in conjunction with generator 122 to form each specific rod in the TPNDB-CPM 114:

$$P ( ρ ) = exp [ \frac{i π}{b} {\vert ρ - d \vert}^{4} ] , \qquad ( 1 )$$

P is an example of a formula of a shifted Radial Quartic Phase Function, where ρ=(u,v) is the vector of transverse coordinates of the aperture plane, d=(dₓ,d_{y}) is the vector of transverse shifts of RQPF determining the amount of the tilt angle of the beam, and b is a real number that controls the longitudinal interval length of the beam. The imaginary unit (−1)^{1/2} is denoted here by i.

The description below provides an example of the creation of a multi-rod beam (equations (3) and (4)).

### FURTHER DISCUSSION AND EXAMPLES

As discussed, the invention provides a method and system capable of optical sectioning using tilted pseudo-nondiffracting beams (TPNDBs) as a linear system's point spread function (PSF). In one example, the invention may upgrade existing widefield microscopes to include the capability of high-resolution sectioning of objects while overcoming obstructions. The inventors have experimentally generated each TPNDB using a radial quartic phase function (RQPF) displayed on the aperture plane. The RQPF induced radial symmetric TPNDB at a sensor space without absorbing light along the beam propagation to the optical sensor. Due to its nondiffracting nature, the TPNDB imaged the entire inspected volume at once. Furthermore, the resulted TPNDB images were used to discriminate between various transverse planes of interest within that volume. In addition, multiple imaging trajectories with different inclinations were combined with an interference-less holographic approach to complement the task of optical sectioning. The invention applies tilted-type COACH to provide high-fidelity of optical sectioning and volumetric object recovery from a single viewpoint by utilizing one or more camera shots, with the addition of a simple digital reconstruction step. While one camera shot generally suffices, the use of two or more shots (and “averaging”) improves the final results. The proposed approach utilizes the property of linear shift invariance to recover the entire volume at once, given a non-scanning single-point response. Although the integration of RQPF as the coded aperture in the COACH system was already suggested for depth-of-field engineering, its application as an optical tomography tool has not been explored yet. For example, when applied to a microscope and based on a spatial light modulator and image sensor device, the STIR system can operate as a low-cost standalone microscope or as an add-on module to an existing microscope to enable the optical sectioning capability. Therefore, STIR provides a low-cost, simple implementation of volumetric imaging apparatus capable of operating under different kinds of illumination and objects of interest.

The experiments have shown that STIR enables optical sectioning with minimal (even one) camera shots and without scanning. Using spatially incoherent light, the microscope could section thick fluorescent samples, proving that the STIR qualifies for labeled and nonlabeled volumetric specimen imaging. For example, the STIR might contribute to biomedical research aiming to follow neuronal brain activity, tissues, and gene function, by an affordable, relatively simple, and highly scalable optical sectioning modality.

The TPNDB maintains a nearly constant intensity along the optical axis to a predefined finite propagation distance. Within that TPNDB trajectory, the light presents a beamlike shape in the transverse directions enabling its use in unconventional imaging tasks. There are publicly known techniques to generate similar TPNDBs, such as axicons, axilens-generated beams, Bessel beams, and other numerical iterative methods. The inventors have experimentally tested a TPNDB generated by RQPF, although other TPNDB generators seem applicable. The inventors preferred using this type of mask because RQPF that generates the PNDB is a phase-only function that can be implemented on a phase aperture while combining other required phase functions such as a diffractive lens, linear phase, and other RQPFs. Notably, the generated TPNDBs can be tilted easily to any direction within small-angle limitations and distributed randomly over the sensor's plane. The inventors have applied the following RQPF form during the experiments:

$$P ( ρ ) = exp [ \frac{i π}{b} {\vert ρ - d \vert}^{4} ] , \qquad ( 1 )$$

P defines a shifted Radial Quartic Phase Function, ρ=(u,v) is the vector of transverse coordinates of the aperture plane, d=(dₓ,d_{y}) is the vector of transverse shifts of RQPF determining the amount of the tilt angle of the beam, and b is a real number that controls the longitudinal interval length of the beam. The imaginary unit (−1)^{1/2} is denoted here by i. By illuminating with a monochromatic plane wave, combining of the RQPF of Eq. (1) with a positive spherical lens of focal length f₂ generates a TPNDB with a starting point at the back focal plane of the spherical lens. The resulting beam has tilt angles defined by the following relations,

$$tan {θ}_{x} = \frac{{d}_{x}}{{f}_{2}} and tan {θ}_{y} = \frac{{d}_{y}}{{f}_{2}} ,$$

where θₓ and θ_{y} are the tilt angles of the beams at the x-z and y-z planes, respectively. An optical imaging system with a PSF of non-tilted PNDB can extend the depth of field (DOF) due to the quasi-diffraction-less capability. However, to provide the sectioning capability, the PSF at each transverse plane within that extended depth of field should be unique to distinguish it from other planes. For example, this feature can be achieved by incorporating two or more TPNDBs with different tilt angles and diverse transverse locations. Consequently, the optical point response at a given plane becomes unique to only that plane in terms of the transverse intensity distribution. To efficiently record and reconstruct the observed 3D scene, the coded aperture correlation holographic technique was integrated with the TPNDBs. The inventors used a particular implementation of COACH, in which the holographic point response consisted of randomly scattered bipolar focal points at the output plane, from which the viewed scene was reconstructed by a nonlinear cross-correlation, denoted by the operator α⊗β and defined by:

$$I ( r ) = {g ( r )}_{α} {⊗}_{β} h ( r ) = {F}^{- 1} \{ {\vert G \vert}^{α} exp [ i \cdot arg \{ G \} ] \cdot {\vert H \vert}^{β} exp [ - i \cdot arg \{ H \} ] \} \qquad ( 2 )$$

where r=(x,y) is the transverse coordinates of the sensor plane, G and H are the two-dimensional Fourier transforms of the bipolar object hologram g(r) and the bipolar point spread hologram h(r), respectively. F⁻¹{⋅} in Eq. (2) denotes a 2D inverse Fourier transform, arg{⋅} is the phase component of the complex quantity, and (α,β) are the regularization parameters of the nonlinear operation that were chosen to maximize the overall signal-to-noise ratio (SNR) of the imaging system. The inventors elaborate below on how combining TPNDBs with COACH enables tomographic capability from a single viewpoint. In addition, the inventors also show that the nonlinear reconstruction (NLR) procedure, when used, reduces background noise levels, increases visibility, and maintains minimum optical power consumption.

As previously noted, for a single viewpoint, 3D tomography of an object, the inventors integrated (a) the concept of sparse COACH; with (b) TPNDBs. By designing an optical system with PSF of several TPNDBs with different tilt angles, as shown in FIG. 5, one can distinguish signals originating from different transverse planes within the volume of interest and reveal occluded images that might be hidden in the original scene. The bipolarity of the holograms in sparse COACH further increased the complexity of the point spread hologram and reduced the background noise of the final reconstructed image from each section. In the reconstruction stage, the adaptive nonlinear reconstruction (NLR) compensated for the resolution losses that occurred due to the expansion of the transverse spot along the trajectory of the TPNDBs.

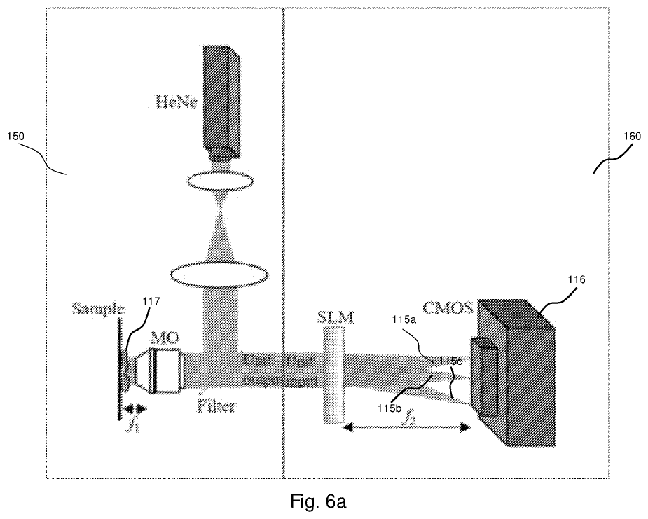

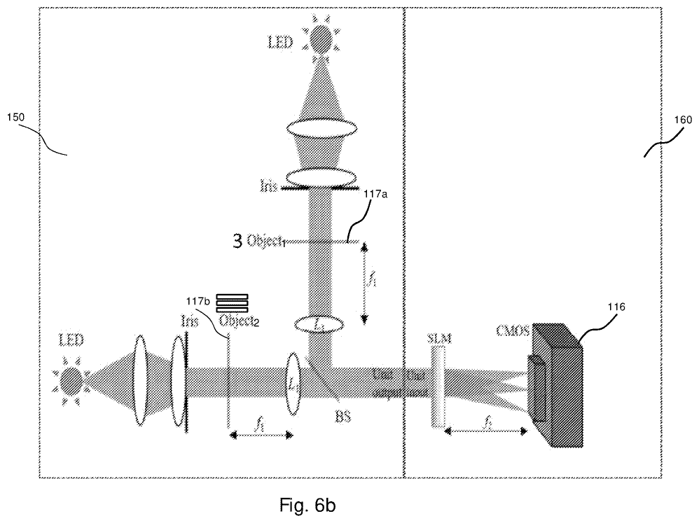

FIGS. 6a and 6b show reflection and transmission configurations that were experimented. FIG. 6a shows a microscope operating in a reflection mode. A HeNe (Helium-Neon) laser source illuminated a sample (object) 117. The MO component is a microscope objective. Chromatic filters might be integrated into the beam-splitter. The SLM (a spatial light Modulator), that was modulated by a combination of Randomly Distributed Dot Generator and a Radial Quartic Phase Function (RQPF) (generator unit 130 of FIG. 3, not shown in FIG. 6a). The CMOS indicated a sensing array.

It should be noted that SLM is not the only option, for example, in case of using one CPM and one camera shot. For example, in the case where a singe CPM is used, a diffractive optical element (static phase mask) can be used as an alternative for the SLM.

FIG. 6b shows a configuration operating in a transmission mode. Two separate slides 117a and 117b, at two different positions, were simultaneously illuminated by two respective LEDs. The illuminations were combined at the beam splitter BS and directed towards and through the SLM, arriving at camera 116. Initially, the distance f₂ was identical for both slides, but later it was varied for one of them to simulate a depth object effect, as further discussed hereinafter.

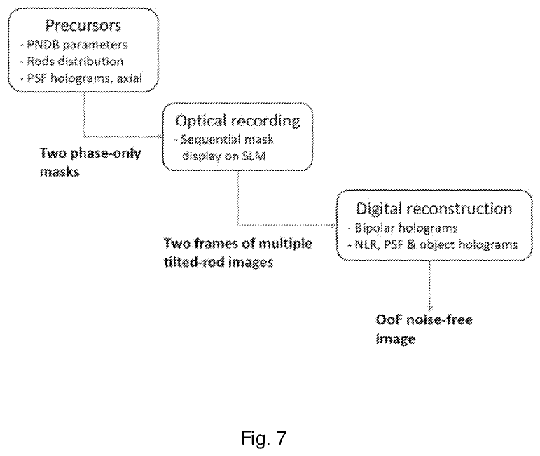

Following the extension of each focal point to a focal rod 115a, 115b, 115c . . . 115n (FIG. 5) in the sparse COACH response, the different tilt of each TPNDB creates a unique distribution of focal points in each transverse slice of the 3D space, enabling efficient rejection of the OoF (Out of Focus) light. FIG. 7 generally illustrates the tested STIR process. In this example, two frames, with two CPMs, respectively, were applied.

To integrate PNDBs into sparse COACH, the point response of the aperture mask should consist of multiple intensity rods that are randomly distributed and tilted, each having a defined starting and end point. The starting point of the entire TPNDBs is at the back focus of the diffractive lens attached to the RQPF. To tilt and distribute the rods, the phase-only mask of Eq. (1) is multiplied by a linear phase to generate a TPNDB with a controlled transverse shift of the starting point with respect to the origin of the sensor plane 116a (FIG. 5). As previously mentioned, a single TPNDB is not sufficient for sectioning, thus, the displayed coded aperture T(ρ) is composed of the product of the diffractive lens with several shifted RQPFs, each with a different linear phase as follows:

$$T ( ρ ) = exp ( - \frac{i π {\vert ρ \vert}^{2}}{λ {f}_{2}} ) Q ( ρ ) , where \qquad ( 3 )$$

$$Q ( ρ ) = {\sum }_{k = 1}^{K} {Θ}_{k} ( ρ ) exp [ \frac{i π}{b} {\vert ρ - {d}_{k} \vert}^{4} ] exp ( \frac{i 2 π ρ▯ sin {α}_{k}}{λ} ) . \qquad ( 4 )$$

K is the number of tilted beams in the PSF, λ is the illumination wavelength, and f₂ is the focal length of a diffractive lens used to satisfy the Fourier relation between the coded aperture plane and the output (sensor) plane. Sin αₖ=[sin α_{k,x}, sin α_{k,y}] is the vector of the linear phase parameters of the k^{th} beam, generating a horizontal shift of f₂ sin α_{k,x} and vertical shift of f₂ sin α_{k,y} from the origin of the sensor plane to each k^{th} TPNDB. Θₖ(ρ) is a multiplexing function that switches randomly between the values 1 and 0 for a given k and satisfies Σₖ₌₁^{K}Θₖ(ρ)=N·M, where the phase aperture is displayed on a matrix of N×M pixels. Consequently, when the phase-only coded aperture of Eq. (3) is illuminated with a plane wave, a set of K TPNDBs are randomly distributed and tilted where they all emerge from the back focal plane of the diffractive lens and extend along a finite length of L, as evaluated below. For a 3D sample with intensity distribution I(r;z) at the object space (r;z)=(x,y;z), the bipolar hologram recorded on the sensor plane is

$$I ( \frac{r}{{M}_{T}} ; \frac{z}{{M}_{T}^{2}} ) * [ {t}_{1} ( r ; z ) - {t}_{2} ( r ; z ) ] ,$$

as achieved by sequentially displaying two independent coded phase masks for proper beam modulation. Here, z is the longitudinal coordinate of the object plane, M_{T}=f₂/(f₁−z) is the system lateral magnification, f₁ is the focal length of lens L₁ in FIG. 6b, and * stands for a 2D transverse convolution throughout this discussion. tₙ(r;z) denotes the intensity distribution of the TPNDBs given by,

$${t}_{n} ( r ; z ) = {\sum }_{k = 1}^{K} Λ ( r - {f}_{2} sin {a}_{k , n} - \frac{z {M}_{T}^{2} {d}_{k , n}}{{f}_{2}} ) , \frac{- L}{{M}_{T}^{2}} \leq z \leq 0 \qquad ( 5 )$$

where Θ(x,y) is the transverse cross-section of each TPNDB computed by magnitude square of the 2D inverse Fourier transform of P(−λf₂v), where the function P is given by Eq. (1), and v=(vₓ, v_{y}) is the vector of the spatial frequency coordinates. The index n=1,2 in Eq. (5) is for the positive and the negative parts of the bipolar point spread hologram. The bipolar point spread hologram is a collection of tilted TPNDBs, half of them positive and half negative, as follows:

$$\begin{matrix}h ( r ; z ) = {t}_{1} ( r ; z ) - {t}_{2} ( r ; z ) \\ = {\sum }_{n = 1}^{2} {\sum }_{k = 1}^{K} {( - 1 )}^{n} Λ ( r - {f}_{2} sin {α}_{k , n} - \frac{z {M}_{T}^{2} {d}_{k , n}}{{f}_{2}} ) ,\end{matrix} \\ \frac{- L}{{M}_{T}^{2}} \leq z \leq 0 \qquad ( 6 )$$

where tₙ(r;z) is given in Eq. (5). The 3D object can be represented as a finite ensemble of 2D slices

$$I ( r ; z ) = {\sum }_{j = 1}^{J} {I}_{j} ( r ) δ ( z ) * δ ( z - {z}_{j} ) .$$

The object hologram g(r) is obtained as the 2D convolution of the magnified image of the object with the bipolar point spread hologram of Eq. (6), as follows:

$$\begin{matrix}g ( r ) = I ( \frac{r}{{M}_{T}} ; \frac{z}{{M}_{T}^{2}} ) * h ( r ; z ) \\ = [ {\sum }_{j = 1}^{J} {I}_{j} ( \frac{r}{{M}_{T}} ) δ ( z ) * δ ( z - {z}_{j} {M}_{T}^{2} ) ] * h ( r ; z ) \\ = {\sum }_{j = 1}^{J} {\sum }_{n = 1}^{2} {\sum }_{k = 1}^{K} {( - 1 )}^{n} {I}_{j} ( \frac{r - {f}_{2} sin {a}_{k , n} - {z}_{j} {M}_{T}^{2} {d}_{k , n} / {f}_{2}}{{M}_{T}} ) .\end{matrix} \qquad ( 7 )$$

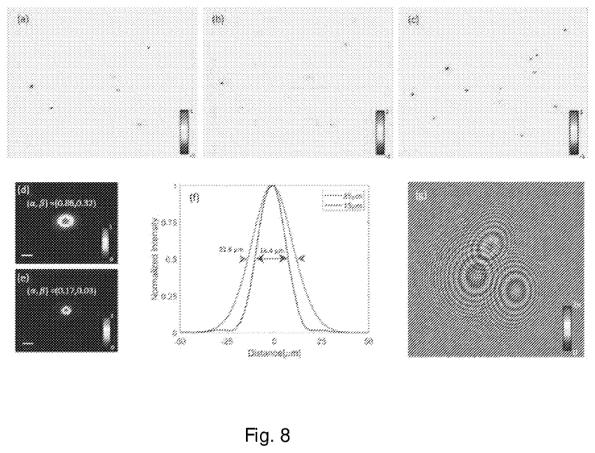

Equation (7) of the acquired object hologram shows the capability of the proposed STIR scheme to distinguish the multiple objects that reside within the volume of interest through the d-dependent lateral shifts of the phase mask. Moreover, the linear shifts due to the angle vectors sin α, enable multiplexing of several TPNDBs distributed in unique spatial signatures. These signatures along z are the point spread holograms used to reconstruct images at any desired axial slice (FIGS. 8(a) and 8(b)), for example. More specifically, FIG. 8 illustrates the calibration and validation of STIR. (a), (b) show two bipolar holograms, each of which is of a different point object located at a different depth of the object space, where the gap between the points is 6.6 mm. Different distributions of the point responses at the sensor plane validate the inclinations of the TPNDBs. (c) is a bipolar hologram of a volumetric object generated by a two-point object of 15 μm and 25 μm diameter (the two slides 117a and 117b shown in FIG. 6b). (d), (e) show two slices from the object space recovered from the single bipolar object hologram. (f) shows pinhole diameters estimated from the cross-sections of the normalized intensity patterns that match the manufacturer's data. The white horizontal bar in all the images equals 30 μm. (g) Example of the used phase aperture T(ρ) in STIR (see Eq. (3) above).

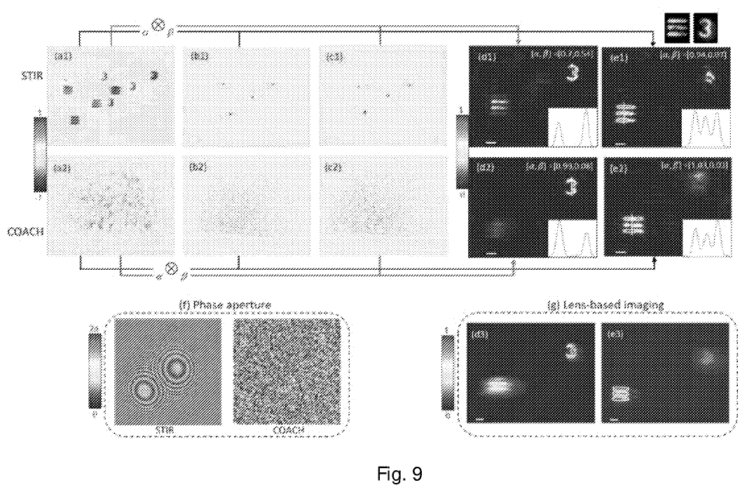

The reconstruction of each slice from the volume of interest is obtained by performing a cross-correlation between the object hologram g(r) and the respective point spread hologram h(r;z) of the desired z slice (see FIGS. 8 and 9) by the NLR scheme outlined in Eq. (2).

FIG. 9 compares the COACH and STIR in rejecting out-of-focus images. (a1) and (a2) show the acquired bipolar holograms for the STIR and COACH and (b1), (b2), (c1), and (c2) the respective point spread holograms used to recover images from the planes of interest (two respective point spread functions for each of the two frames used). Images (d1), (e1) show the NLR result for an image from the two planes of interest defined by the two slides 117a and 117b of FIG. 6b, and obtained by STIR. Images (d2) and (e2) indicate the same as (d1) and (e1), but for COACH. Insets (the 4 figures within 9(d1), 9(e1), 9(d2), and 9(e2) of the graphs on the white background): Vertical cross-sections of the recovered intensity distributions. The ground truth image of each reconstructed object is depicted in the upper right corner (above image (e1)) in black and white [symbol] —they have been captured from planes 117a and 117b by a regular camera. Images (f) show examples of phase apertures for each of the two STIR and COACH techniques. The STIR mask includes the diffractive lens (see Eq. (3)), whereas COACH does not. Images (g) show lens-based imaging of the two planes (117a and 117b in FIG. 6b, where each plane comes to focus by changing the focal length of the imaging lens. Each vertical color bar corresponds to images to its right. The white horizontal bar in all the images equals 60 μm.

The length L of the nondiffracting interval of each TPNDB is calculated as follows. First, it is assumed that the aperture T(ρ) of Eq. (3) is illuminated by a plane wave and that the aperture (the CPM) is a single non-shifted RQPF without linear phase factors or any tilt angle (i.e. [d, sin α]=[0,0]). The wavefront beyond the aperture is

$$exp [ \frac{- i π {\vert ρ \vert}^{2}}{λ {f}_{2}} + \frac{i π {\vert ρ \vert}^{4}}{b} + \frac{i 2 π {z}^{′}}{λ} ] ,$$

where z′ is the axial coordinate with the origin at the aperture plane.

The light rays diffracted from the edge of the aperture with the radius R, |ρ|=R create the endpoint of the TPNDB, where the other end is the back focus of the lens. Since the gradient of the scalar wave function is orthogonal to its equi-phase surfaces, the ray that propagates from a particular point at the wavefront is parallel to the gradient of the wavefront calculated at this point. The wavefront gradient at the aperture edge is

$$∇ {S}_{\vert ρ \vert = R} = ( \frac{- 2 π R}{λ {f}_{2}} + \frac{4 π {R}^{3}}{b} ) \hat{r} + ( \frac{2 π}{λ} ) \hat{z}$$

where \hat{r} and \hat{z} are unit vectors in the transverse and longitudinal directions, respectively.

Therefore, the angle θ of the marginal ray beyond the aperture with the z′ axis satisfies both the following two relations:

$$tan θ = \frac{R}{{f}_{2}} - \frac{2 λ {R}^{3}}{b} = \frac{R}{{f}_{2} + L} \qquad ( 8 )$$

Extracting L from Eq. (8) indicates that the length of the nondiffracting interval is

$$L = \frac{2 λ {f}_{2}^{2} {R}^{2}}{( b - 2 λ {f}_{2} {R}^{2} )} .$$

According to this last expression, L can range between 0, for infinite values of b, or to infinite length, for b=2λf₂R². However, as much as L is long, the finite peak intensity of each TPNDB is reduced by a factor of L. To keep the PSF of sparse dots with relatively high SNR, the length of L should be limited to a fraction of f₂. Hence, if one limits the rod's length to L=f₂/Q, where Q>2, then bₘᵢₙ≥2λf₂R²(1+Q). Also, note that the length of the TPNDB put a limit on the length of the object scene to be no longer than L/M_{T}².

Note that the suggested holographic tomography apparatus is implemented by a single aperture containing the product of the diffractive lens with several shifted RQPFs, according to Eq. (4). Such setup is modular and can be tuned to various sizes of volumetric objects as well as to different values of magnification and field-of-view, as outlined in the discussion about the experiment results below. In addition, the coded phase masks of the various beams are staggered using random multiplexing implemented by the functions Θₖ(ρ). Hence, the different beam properties can be tuned separately, and the beam intensities can be equalized by non-uniform allocations of pixels for the various beams. On the other hand, a limitation of this scheme is the minimal gap between two successive slices that can be resolved. To demonstrate the invention's applicability, the slices in the experiment are the transverse planes along the longitudinal z-axis. While the structure of FIG. 6b demonstrates the invention with only two slides, there is no limitation on the number of slides (and respective “slices”). More specifically, in the transmission structure of FIG. 6b, the “slices” are the two slides (117a and 117b), and in the reflective structure of FIG. 6a the “slices” are the various longitudinal heights of sample 117. Concerning the experimental configuration shown in FIG. 6b, and to avoid overlap between the responses of two consecutive slices, the minimal gap Δzₘᵢₙ between two successive slices is Δzₘᵢₙ=S/tan θₘₐₓ, where S is the diameter of the beam's spot, assuming the beam is approximately uniform along the diffraction-less range L, and θₘₐₓ is the maximal tilt angle of the beam. For a diffractive lens of diameter D and focal length f₂, the transverse resolution limit leads to the approximation S≈λf₂/D. The maximal beam's tilt angle is

$${θ}_{max} = {tan}^{- 1} [ \frac{D}{2 {f}_{2}} ] ,$$

where D is the RQPF's diameter and D/2 is the maximum shift of the RQPF. Therefore, the minimal resolved gap in the sensor plane is Δzₘᵢₙ=S/tan θₘₐₓ=2λf₂²/D², which becomes Δz_{min,obj}=2λ f₁²/D² in the object space (assuming |zₘₐₓ|<<f₁).

The experiments are now described in more detail. The general structure of the experimental apparatus for testing the STIR technique is shown in FIG. 6b. The apparatus generally includes two main units, an illumination unit 150 and an image acquisition unit 160. The acquisition unit modulates the incident waves and captures the intensity images of the 3D object in two shots used for synthesizing the bipolar hologram. The illumination unit (two sub-units in this case) operates either in transmission (FIG. 6b) or reflection (FIG. 6a) modes and illuminates the volume of interest. The acquisition unit 160 comprised an electrically addressed spatial light modulator (SLM) and a complementary metal-oxide-semiconductor (CMOS) image sensor. The SLM (Holoeye PLUTO-2, 1920×1080 pixels, 8 μm pixel pitch, phase-only modulation, reflective) was positioned at a distance of f₂=580 mm from the CMOS camera (Hamamatsu ORCA-Flash4.0 V2 Digital CMOS, 2048×2048 pixels, 6.5 μm pixel pitch, monochrome) and modulated the incoming signal according to the SLM's phase-only mask (Eq. (3)). Beyond the SLM, the light propagated in the free space until captured by the CMOS camera. Two different illumination units (FIGS. 6a and 6b) were used according to the type of the inspected object (a physical object in FIG. 6a and slides in FIG. 6b. Accordingly, two different refractive lenses L₁ were used for the transmission and fluorescent mode demonstration, one with a standard numerical aperture equal to ˜0.064 (f=200 mm, D=25.4 mm) and the other with a microscope objective (MO, Olympus PLN 10×, NA=0.25), respectively. Note that due to the short working distance of the MO, in the fluorescent mode, the inventors employed an additional relay system (not shown in FIG. 6a) to adjust the output spot of the MO to the SLM's size. For the 3D phantom transmissive objects (1951 USAF grating and digits), the inventors used two identical channels with spatially incoherent light-emitting diodes (Thorlabs LED635L, 170 mW, λ=635 nm, Δλ=15 nm). For the fluorescent object, a spatially filtered, expanded, and a collimated laser beam (Helium-Neon, AEROTECH, maximum output power of 25 mW @ λ=632.8 nm) was used to illuminate the sample (Focal Check, 6 μm diameter Fluorescence microspheres) in normal incidence through the MO and the emitted light was collected by the same MO toward the acquisition unit. The refractive lens L₁ collects light from the 3D input object, transfers it toward the SLM, and essentially operates as the interface between the two units. For the reconstruction step detailed below, a set of bipolar point spread holograms was acquired by placing a 15 μm pinhole (Newport 910PH-15, high-energy pinhole, molybdenum) at different planes within the object's volume of interest. Alternatively, the set of these reconstructing functions could have been digitally generated by the knowledge of the linear shifts and TPNDB shifts according to Eq. (4) and the specifications of the used optics.

Compared to the proposed STIR throughout this study, all other imaging modalities were implemented on the same optical configuration simply by replacing the phase-only pattern displayed on the SLM. A diffractive spherical lens was displayed on the SLM for regular, lens-based imaging. Each lens had a focal length that satisfied the imaging equation (595 mm and 620 mm) for each object located at a different distance from the setup. A coded phase mask was synthesized for COACH using a modified phase retrieval algorithm to ensure a relatively homogenous distribution across a predefined window size at the image sensor plane. The COACH with long DOF (CLDOF) modality was achieved by displaying a coded aperture that is like the one used in the proposed tomographic system, but without tilting the beams, i.e., the parameter d_{k,n} of Eq. (4) was set to zero for any k and n. The object recovery in the COACH and CLDOF modalities was performed by an NLR according to Eq. (2), where an appropriate point spread hologram h(x,y) was selected from a prerecorded set for each one of the modalities.

While the overall characteristics of the imaged volumetric object might be known and can be used to design the coded aperture for optimal STIR performance, its detailed features are a priori unknown. This turns the NLR into a non-trivial task, as the optimal parameters for the nonlinear cross-correlation vary with the experimental conditions and the inspected object. Therefore, a blind figure of merit must be associated with NLR in order to assess the performance and determine the optimal pair of regularization parameters (α,β) for a given slice within the volume, without exactly knowing the image that should be recovered. Previous COACH studies have proposed the entropy of the recovered image as a suitable cost function for finding the optimal (α,β) pair. However, they only sampled the regularization parameters at constant intervals. Here, the inventors propose an adaptive scheme that iteratively searches the minimum entropy and the related regularization parameters based on a two-variable gradient descent (GD) algorithm. The proposed GD-NLR thoroughly looks for the (α,β) pair that results in the sharpest PSF among the infinite possibilities. Finding the optimal parameters is important for TPNDB-based optical systems since there is an inevitable loss of the transverse resolution along the trajectory of such beams. Additionally, GD-NLR is expected to benefit the mechanism of OoF rejection in each slice, as it diminishes the intensity of the signals that do not match the accurate distribution of focal points at that slice.

In the experiments, the GD-NLR algorithm was initialized with regularization parameters of a phase-only filter, i.e., (α,β)=(1,0), and the entropy σ(α,β) of the reconstructed slice was calculated according to σ(α,β)=−Σ_{x,y}I′(x,y)log[I′(x,y)]. Here, I′(x,y) is the normalized intensity of the recovered image at the current slice obtained by dividing I(x,y) with the value of the summation Σ_{x,y}I(x,y). Next, the regularization parameters were updated as follows, [α,β]^{q+1}=[α,β]^{q}−γ∇σ([α,β]^{q}), where γ is the step size of the algorithm and V denotes the gradient evaluated at the regularization parameters values of the current q iteration. Based on these updated values, a new recovery for the given slice with an updated entropy was obtained and compared to the previous value. If the trend is positive i.e., the entropy decreases, the algorithm proceeds to another iteration, and the regularization parameters are updated accordingly. Otherwise, a local minimum has been achieved, and the search is over. To ensure that a global minimum within the reasonable range of (α,β) was obtained, the described algorithm was repeated three times with different γ values to a point where the entropy variations were insignificant.

The calibration and validation of the system were performed as follows. As a preliminary step to validate the proposed approach and inspect its performance, the inventors tested the recovery of an image of two point-like objects positioned at two different depths. To this end, two pinholes of different diameters, 25 μm and 15 μm, were placed out of the Rayleigh range of an equivalent lens-based imaging system with a longitudinal separation of 6.6 mm between them. The distribution of the sparse response at the sensor plane varies laterally with the longitudinal location of the object according to the trajectory of each TPNDB, as explained above and visualized in FIG. 8 (images (a) and (b)). The inclination angle, starting point, and endpoint of each TPNDB were governed by the phase mask parameters and were used to capture the entire volumetric object space and to distinguish images from different transverse planes with high fidelity. FIG. 8 (image (c)) shows the acquired bipolar hologram for the space consisting of the response of two longitudinally separated pinholes. The 3D image of the points was recovered solely from this object hologram. Each pattern of FIG. 8 images (a) and (b)), acquired during the one-time calibration procedure, was cross-correlated with the bipolar object hologram in an adaptive NLR framework. The NLR enables optimization of the system's performance and rejects OoF noise. Since the slices of the volumetric object are a priori unknown, the entropy of the recovered signal from each plane is used as a blind metric to minimize both the OoF noise and the size of each diffraction-limited spot. FIG. 8, images (d) and (e), illustrate the recovered slices of interest from the 3D object space, namely those containing one of the two points. The normalized intensity profile along the horizontal cross-section is shown in FIG. 8-(f). The diameter of each point object residing within each slice of interest is estimated by the full width at half maximum (FWHM) of these plots. FWHM values of 22.6 μm and 16.4 μm measured in FIG. 8-(f) fall within the manufacturer tolerance for the 25 μm diameter and 15 μm diameter pinholes, respectively. These results emphasize that by incorporating the almost-diffraction-less property of TPNDBs and the randomness of sparse COACH, one can slice the imaged volume and recover one transversal plane at a time, but from a single hologram. As demonstrated next, this approach also applies to tomographic imaging, where regions of interest from different planes occlude each other in a situation that usually requires sampling from more than one viewpoint.

The OoF (out of focus) noise was rejected as follows. The inventors applied holographic techniques based on their imaging merits to reject OoF noise: (a) interference-less COACH; and (b) STIR. The inventors created an object space, placing two transmissive objects (slides) before the system's aperture. The objects were placed at two planes separated by about 4 mm, thereby enabling the acquirement of bipolar holograms—see FIGS. 9(a1) and 9(a2). Based on the optical specifications, this separation level causes the two objects to reside at the two ends of the Rayleigh range, such that the OoF signal from the adjacent plane is considerable. To perform a reliable comparison between the two modalities, the experimental conditions, and the digital procedures were matched to each other. More specifically, the same exposure time was defined for all the recordings, all the recorded holograms were bipolar, and the NLR scheme performed all the digital reconstructions. FIG. 9 emphasizes that both methods use a double shot-based bipolar two-dimensional (2D) hologram to recover the multi-plane image by applying nonlinear cross-correlation with the designated point spread hologram.

Interestingly, the results show that either approach can be used to diminish OoF noise, as the qualities of the recovered signals are comparable in terms of visibility and noise. Reducing the OoF stamp is essential to achieving high-fidelity recovery of the entire 3D space. Compared to lens-based direct imaging—FIG. 9(g), both COACH and STIR decently image a slice by highlighting objects from one plane at a time with minimal traces from the structures of the adjacent plane. However, and as elaborated below, there is a systemic advantage to using STIR. The inventors provide below an answer to whether these approaches are still comparable when the task of optical tomography is the goal.

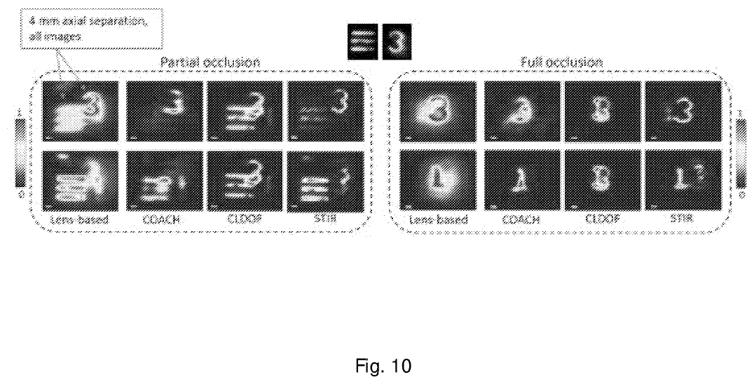

Experiments relating to a single viewpoint tomography (without scanning) are now discussed. The imaged scene was modified so that an image from one plane obscures that from another plane by changing the lateral locations of the objects. In this example, if one object obscures the other, then this configuration is equivalent to one transparent box-shaped object in which the far slide is displayed on the far side of the box, and the close slide is on the near side of the box. All the other experimental conditions were left unchanged. In such a scenario, a successful reconstruction of all objects located at the different planes is considered tomographic imaging, a challenging task with data captured from only a single viewpoint without scanning along the z-axis. FIG. 10 compares holographic tomography of a volumetric scene by several techniques. STIR provides superior performance compared to other approaches when objects from two transverse planes are separated by a 4 mm overlap. The ground truth image of each reconstructed object is given in the upper middle in black and white. The white scale is equivalent to 30 μm. FIG. 10 (left dashed frame—partial occlusion) illustrates the NLRs of each plane of interest based on a single bipolar hologram and lens-based imaging. Here, the compared holographic techniques are interference-less COACH, STIR, and CLDOF achieved by PSF of straight (non-tilted) light rods (PNDBs). The latter is incorporated into the experiment to emphasize the significance of the light beams' inclination for tomography, an essential contribution of the present invention. Clearly, STIR accomplishes sectioning of the thick scene, whereas all the other modalities do not. It seems that the occluded signal cannot be recovered from a COACH hologram without considerable noise, and the recovered distorted signals contain undesired traces of the object that resides in the adjacent plane. In STIR, however, the multiple and pseudo-random transverse dislocations between adjacent planes enable a full recovery of the occluded image, leading to a complete and accurate reconstruction of objects from each plane of interest. Like STIR, CLDOF extends the in-focus range and simultaneously captures a hologram that contains multiple planes of interest in focus. However, in CLDOF, all the image replicas include the same spatial distribution regarding the 3D scene (as elaborated below). Hence, the CLDOF cannot distinguish the different planes within the volume, and it recovers all the structures with the same quality.

As an additional trait, the inventors inspected how each technique performs under a full overlap between the objects from each plane. In this demonstration, the vertical grating was replaced by the digit ‘1’, and the transverse location was set accordingly. FIG. 10 (right dashed frame) shows that the tilted beams approach of STIR can apply optical sectioning, exposing the fully obscured object with high fidelity. On the other hand, COACH and CLDOF could not discover that there are multiple planes of interest, and the reconstruction results are highly distorted.

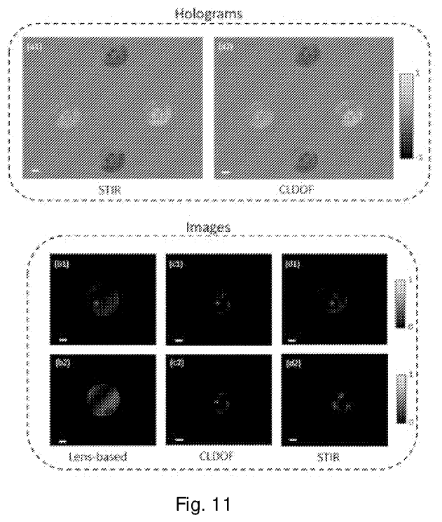

Fluorescent tomography using STIR is now discussed. To demonstrate the versatility of the proposed STIR system, the inventors inspected the system's operation under the reflected illumination of fluorescent light. The significance of slicing a microscopic fluorescent sample is high, particularly when thick and sparse specimens are involved. Therefore, a sample including fluorescent microspheres was illuminated by excitation laser light, and fluorescent emission light from the surface of the observed microspheres was measured. The emitted light entered the STIR system, assuming these microspheres are randomly distributed in the 3D object space between the microscope slide and the coverslip. FIG. 11 shows holographic tomography of fluorescent microspheres using STIR. (a) shows bipolar holograms of several micrometers thickness fluorescent microspheres sample (6 μm diameter) for TPNDB (STIR) and non-tilted PNDB (CLDOF). (b) shows lens-based images with different f₂ values, where two in-focus planes within the specimen can be observed in (b1) and (b2). (c) shows that the distribution of the CLDOF images of every transverse plane is the same, and the specimen cannot be sectioned. (d) shows that, to the contrary, different distributions of the three captured spheres are shown in STIR images, enabling sectioning of the specimen, as shown (d1) and (d2). The white scale equals 15 μm in all the images.

FIG. 11(a1) illustrates a bipolar hologram with four different replicas from the sample's region of interest, where each replica has its own unique distribution of the three observed microspheres. In contrast, the equivalent distributions of the microspheres in the bipolar CLDOF hologram shown in FIG. 11(a2) are the same for all the replicas. Lens-based images of the two different planes within the imaged space are shown in the lower frame images (b1) and (b2). One contains a single, high-intensity fluorescence microsphere, and the other contains two faint microspheres that can hardly be seen due to their low fluorescent emission. Next, the inventors show how the tilted light rods are exploited to obtain multi-plane images from the single bipolar hologram of FIG. 11(a1) and to reconstruct the two-plane image. The variability of the tilt angles of each replica in the STIR hologram is used to differentiate between objects that reside in different planes, leading to a slice-by-slice recovery of the entire volumetric space from a single viewpoint. FIG. 11 images (c) and (d) show the reconstructions of the two planes of interest in both techniques, where it is evident that STIR recovers only fluorescent objects in focus while the other noisy signal is washed out, as opposed to CLDOF that is unable to differentiate between the planes of the volume. It is interesting to note the relative intensities of the fluorescent structures from both planes as they appear in each imaging technique. While the pair of emissive objects remains very faint compared to the stronger ones in the CLDOF images (c1) and (c2), in the STIR reconstruction (d2), it appears much brighter and more focused. Remarkably, the contrast of the fluorescent signal on top of its immersive background is enhanced by using holographic imaging, as can be seen by comparing the intensity of the microspheres' background in (b), (c), and (d). This improved contrast of the fluorescent signal is attributed to the multiple replications of the sparse COACH system, which is more power-efficient, and to the NLR, which consequently suppresses background noise. The two aforementioned features turn STIR into an attractive instrument to image thick and low-light fluorescent objects.

The invention demonstrates how COACH with PSF of TPNDBs can be harnessed to obtain image sectioning and tomography from a single viewpoint without two-beam interference and by an optical system lacking moving parts or scanning capabilities. The tomography is achieved by laterally shifting each RQPF at the aperture plane by a different amount, and by that, several PNDBs are tilted at various angles. The pseudo-random nature of the optical response of COACH systems enables section-by-section imaging of the observed volume as the objects propagate through different trajectories. Moreover, COACH has benefited the proposed system in terms of the lateral resolution via NLR, which is regarded as a significant contribution to PNDB-based imaging systems.

In the first experiment, the inventors tested the axial-location-gating capability of STIR by differentiating two-point object located at different longitudinal planes. Although the longitudinal support of STIR is theoretically infinite, keeping its values in a certain percentage of the focal length f₂ of the diffractive imaging lens is recommended to avoid severe resolution impairment. Here, the inventors used an axial separation that is equal to ˜10% of the used focal length f₂ to verify the NLR algorithm performance in accounting for the peak intensity reduction and restoration of the original resolution capability. To further analyze the performance of the proposed apparatus adequately, the inventors compared it with two closely related 3D imaging holographic modalities in two important tasks of rejection of OoF light and tomography. Previous studies have shown that the COACH system can be used as a 3D imaging tool rejecting OoF light. Thus, COACH performs better than lens-based imaging in the task of OoF signals rejection, as shown in FIG. 9. Interestingly, when compared with STIR, COACH presents somewhat better performance, with the OoF signal less prominent in the final reconstruction. Nonetheless, it should be noted that COACH is less power-efficient than sparse COACH; therefore, these reconstructions were obtained by increasing the illumination power up to 10 times in the hologram acquisition step. The alternative of increasing the exposure time of the recording device also has shortcomings, as more background noise is likely to persist in the final reconstruction, and the temporal resolution is impaired. Importantly, in case objects from the various slices laterally overlap each other, the performance of STIR is superior to COACH in terms of the OoF rejection. From the results of FIG. 10, it can be seen that COACH cannot accurately describe the objects at different slices within the volume. The main reason is that the objects residing at nearer planes, relative to the system's entrance pupil, hide signals from farther slices that are not properly registered in the chaotic hologram. In the recovery stage, the reconstructing function searches to pair with this missing information and thus fails to execute tomographic sectioning. On the other hand, STIR registers the hidden images from the farther slices due to the multiple and different tilted trajectories. Therefore, STIR can perform optical sectioning in this challenging situation from a single viewpoint.

Finally, The inventors demonstrated a technique for handling fluorescent samples. Fluorescent imaging is an efficient tool to image transparent tissues, organs, and others. In these kinds of specimens, the object space tends to be sparse, and the tagged objects might be occluded by others from adjacent planes, making them difficult or even impossible to observe. FIG. 11 shows how a few micrometers-thick samples of fluorescent microspheres were successfully imaged using the proposed STIR. Two different slices of the sample were separately recovered, exposing different images of the sample. For comparison, the CLDOF modality could only obtain the entire volume focused without sectioning, making it hard to recover the volumetric object in a slice-by-slice fashion. The contribution of STIR here is rooted in the ability to acquire a single bipolar hologram that contains in-focus images of objects from various depths within the sample and to digitally assign a given object to the slice from which it originated. Compared to the alternative of scanning the volume by changing the imaging lens's focal length (see FIG. 11(b)) or by physically axial scanning for more than two planes of interest, STIR is more time-efficient and robust for motionless tomography. This demonstration also highlights the ability to digitally generate the various point-spread holograms for the different planes of interest within the sample. For the present case of several micrometers thick volume, obtaining the set of reconstructing functions experimentally with standard optomechanical elements of micrometric precision is difficult. Alternatively, the characteristics of the coded aperture used to generate the multiple TPNDBs are exploited to create a different distribution of dots at each plane. The tradeoff of using this approach is the influence of uncontrolled aberrations and intensity variations, which are captured in the experimental calibration stage and are further eliminated in the NLR process.

While some embodiments of the invention have been described by way of illustration, it will be apparent that the invention can be carried into practice with many modifications, variations, and adaptations and with the use of numerous equivalent or alternative solutions that are within the scope of persons skilled in the art, without departing from the spirit of the invention or exceeding the scope of the claims.

1. A single viewpoint imaging system for optically sectioning an object from a single viewpoint, comprising:
a. a TPNDBs (tilted pseudo-nondiffracting beams)-type coded phase mask (CPM) configured to receive a light beam passed through the object or reflected therefrom, and to produce TPNDBs directed towards a sensing array;
b. said sensing array configured to record an image formed by said TPNDBs impinged thereon;
c. a processor configured to:
(i) separately cross-correlating said recorded image with at least one point-spread function (PSF) previously acquired or calculated at the same system with the same CPM, each said PSF reflects a point object positioned at one specific longitudinal distance, respectively, from said array;
(ii) storing the results of said separate cross-correlations, each such cross-correlation result relates to an image of another section, respectively, of the object; and
(iii) uniting all said cross-correlation results to reconstruct a final image of the object.

2. The system of claim 1, wherein said CPM is produced by a generator unit combining a randomly distributed Dot generator with a Radial Quartic Phase Function (RQPF).

3. The system of claim 1, wherein said processor further applies a nonlinear reconstruction (NLR) procedure on said final image of the object, thereby increasing the signal-to-noise ratio and producing an enhanced final image of the object.

4. The system of claim 1, wherein a spatial light modulator (SLM), together with said generator unit, is used to produce said CPM.

5. The system of claim 1, applied within a microscope.

6. The system of claim 1, applied as an add-on of a widefield microscope.

7. The system of claim 1, wherein each of said TPNDBs impinges at a different array location, and at a different tilting angle on said sensing array.

8. A single viewpoint imaging method for optically sectioning an object from a single viewpoint, comprising:
d. providing a TPNDBs (tilted pseudo-nondiffracting beams)-type coded phase mask (CPM);
e. generating a light beam which illuminates or passes through the object and directing the light beam that passed through or reflected from the object towards said CPM, thereby to produce TPNDBs at a sensing array;
f. recording an image formed at said sensing array by said TPNDBs impinged thereon;
g. separately cross-correlating said recorded image with at least one point-spread function (PSF) previously acquired or calculated at a same optical arrangement with the same CPM, each said PSF reflects a point object positioned at one specific longitudinal distance, respectively, from said array;
h. storing the results of said separate cross-correlations, each such cross-correlation result relates to an image of another section, respectively, of the object; and
i. uniting all said cross-correlation results to reconstruct a final image of the object.

9. The method of claim 8, wherein said CPM is produced by a generator unit combining a randomly distributed Dot generator with a Radial Quartic Phase Function (RQPF).

10. The method of claim 8, further applying a nonlinear reconstruction (NLR) procedure on said final image of the object, thereby to increase signal to noise ratio, and to produce an enhanced final image of the object.

11. The method of claim 9, wherein a spatial light modulator (SLM), combined with said generator unit are used to produce said CPM.

12. The method of claim 8, applied within a microscope.

13. The method of claim 8, applied as an add-on process within a widefield microscope.

14. The method of claim 8, wherein each of said TPNDBs impinges at a different array location, and at a different tilting angle on said sensing array.
